(19) United States
(12) Patent Application Publication
(10) Pub. No.: US 2014/0191482 A1
(43) Pub. Date: Jul. 10, 2014

(54) 3-SKI SNOWBIKE

(71) Applicant: Simon BASSEIN, Los Angeles, CA (US)

(72) Inventors: Simon Bassein, Los Angeles, CA (US); Jed Bassein, Los Angeles, CA (US); Matthew Bassein, Los Angeles, CA (US)

(21) Appl. No.: 13/261,803

(22) PCT Filed: Feb. 1, 2013
(86) PCT No.: PCT/US2013/000025

§ 371 Date: Jan. 27, 2014

Related U.S. Application Data
(60) Provisional application No. 61/594,556, filed on Feb. 3, 2012.
(60) Provisional application No. 61/594,630, filed on Feb. 3, 2012.

(51) Int. Cl. B62B 13/08

(52) U.S. Cl. CPC B62B 13/08
USPC 280/15

(57) ABSTRACT

The 3-ski snow bike designs transform bicycles into 3-ski snow bikes that can be used for downhill and cross country snow biking. It consists of a bicycle frame with 1 permanent front ski instead of the front wheel and 2 detachable rear skis on each side. The 2 rear skis provide good snow bike stability while the short front ski allows for easy maneuverability. These 3-ski designs are adaptable to most types of bicycles with pedals and rear wheel of bicycle attached and used to move the 3-ski snow bike cross country, or removed for downhill snow biking. The steering bar in addition to controlling the turns with the front ski can be used to move the 2 rear skis up/down, enabling the snow bike to lean during turns, or the rear skis can move freely for easier control on steep slopes. The 3-ski snow bike also has a breaking mechanisms (brake bar digging into snow), rear shocks for a smooth ride, and ski attachments that easily connect to most downhill ski bindings, so that the rider can change the length and type of rear skis, depending on size, ability, and snow biking terrain.

### TECHNICAL FIELD

Skiing, Biking (Combining biking and skiing by attaching 3 skis to a bicycle).

### BACKGROUND ART

Most current ski-bikes are made by removing the front and back wheels of an existing bicycle and attaching a front and rear skis instead of wheels. This enables a person to ride on the 2-ski snow bike down the snow covered mountain. However, the 2-ski bikes are not very stable, long front ski makes turning harder, the ski length are not easy to change because the front ski interferes with the back ski, and kid's skis do not have sufficient surface to support an adult rider requiring special wider skis. Our 3-ski bike design (short ski in the front and 2 long skis in the back) is superior because the 3-ski snow bike is more stable, especially when the snow bike is sliding. And, the 3-ski bike design shifts the rider's weight back, allowing a smaller ski to be used in the front, which is desirable for efficient turning.

The other 3-ski sleds and snow vehicles connect rear skis to a frame with a solid bar that does not allow up/down rear skis motion, U bar with springs that permit rear skis to move (U.S. Pat. No. 5,335,925), leaf springs supports (EP 0799763 A2), and parallelogram arrangement supports (US 2007/0257452). This invention uses other mechanisms like horizontal pivot bar, steering bar, vertical pivot bar, or 2 swinging spring shocks and rear supports to connect rear skis to bicycle frame. Our designs allow the 2 rear skis to move up/down, permitting the 3-ski snow bikes to lean into turns, similar to biking and skiing motion.

Additionally a lot of ski bikes do not have a breaking system. Rider uses his/her feet to drag along the snow or side slide with the ski bike to slow and stop the ski-bike. Our 3-ski snow bikes have 2 braking system, a bar dragging on/digging into the snow and snow plowing by pushing out the outside ski.

Other cross country snow vehicles (with a track or rear wheel) are similarly designed as a 2-ski bike with its flaws. Our cross country 3-ski designs keep rear bicycle wheel for moving and attaches 2 rear skis on each side of rear wheel for sliding and balance.

### ADVANTAGES OF INVENTION

The advantages of the 3-ski bike design are: (1) The 1 ski in the front and 2 skis on the sides/rear, make the 3-ski snow bike stable. (2) The short front ski allows for better maneuverability. (3) Raising the steering bar with extension tubes changes the angle rider sits on the snow bike, thus allowing better load distribution and more natural skiing position for the rider. (4) Enabling the rear skies to move up/down allows the 3-ski snow bike to lean during turns. (5) The two rear shock springs and stabilizing spring/turnbuckle provide for a smooth ride and even load distribution over snow. (6) The 3-ski snow bike is also equipped with 2 braking systems in addition to turning and sliding skiing techniques that can be used. (a) The hand brake system utilizes the bicycle brake or gear cable to lift front ski, and (b) the foot brake that pushes a solid rod into the snow to provide drag for quicker braking and stopping. (7) The snap in ski attachment allows the rider to connect different length and types of skis easily. And (8) the 3-ski design can also be adapted to a complete bicycle [with pedals & rear wheel] so that the 3-ski snow bike also moves cross country.

### DISCLOSURE OF INVENTION

This invention uses an existing bicycle frame (with or without rear wheel) and attaches 1 front ski and 2 rear skis to the bicycle frame. The front bicycle wheel is replaced by a short front ski that is connected by 2 extension tubes at the bottom such that the front ski pivots between them. The top end of extension tubes go over the bottom of front shocks, rigidly secured and support the front end of the snow bike. The front brake cable is extended and lifts the front of ski to help with snow biking through powder.

The back end of the 3-ski snow bike is supported by 2 rear skis that are attached with 2 support pipes to the sides of bicycle frame. The support pipes are connected to frame such that they allow the up/down motion of rear skis. 2 points of attachment are required for stability and can be done a couple different ways. (1) Cross-connecting the front of support pipes to the steering bar, (2) horizontal pivoting bar with a bolt in the middle through frame and support pipes attached at ends, (3) swinging rear springs attached by a through bolt at sides of pedal opening, (4) vertical pivoting bar with bolt in middle to frame, or (5) vertical pivoting bar with 2 rear supports at ends and a bicycle rear spring in the middle. Our different designs use combinations of these connections to effectively transmit the load of the rider to the rear skis, while allowing the required up/down motion for leaning.

The 2 support pipes continue back where they connect to the rear skis by snap in attachment that resembles standard ski-boot shape for easy connection of most skis. Foot lever brakes are mounted on the back section of each support pipe, and work independently by pushing a plate into the snow when force is applied to the foot brake pedal, or push the outside ski out. Also the front brake or gear cable is extended to tip of front ski for easier motion through powder.

Our 1^{st} design connects the front of support pipes to steering, with the rear of frame supported by 2 swinging rear shock springs. They are pin connect to the middle of 2 support pipes that run from steering bar to rear skis. The 2-¾″ steel support pipes are bent to shape described later, and cross each other such that they are able to move up, down and sideways without interfering with each other. This enables the 3-ski snow bike to lean and turn. The 2 rear spring shocks that attach at mid span of the support pipes are pin connected on top to the side of bicycle frame at pedal opening (one on each side of the bicycle frame), and swing such that they allow the up/down motion of rear skis. The bottom of the rear shock springs are also pin connected to the end of a brake bar or to the support pipe directly. Horizontal turnbuckle or stabilizing spring connects the 2-¾″ support pipes or foot brake levers to prevent skis from sliding out. Additional support of rider can be provided by attaching the rear bicycle spring in the middle of a pivot bar with rear supports at each end going straight to ski attachments. (For snow bikes with rear wheel, the support pipes are bent such that the swinging springs connect to bicycle spring and their motion does not interfere with pedaling.)

The 2^{nd} design connects the crossing support pipes to steering in front and a vertical pivot bar in the middle. This configuration provides the freedom of motion of rear skis in addition to steering control. The steering bar connection controls the leaning of the 3-ski snow bike, and the vertical pivot bar provides additional up/down motion of rear skis on steep slopes. Foot pedal brakes are installed on each support pipe to provide braking for the snow bike. (In snow bikes with rear wheel, the vertical pivot bar is also moved higher and support pipes bent such that they do not interfere with pedaling.) 3^{rd} design also connects the crossing support pipes to steering in front and the rear of support pipes attach to the bicycle rear shock by a horizontal pivot bar and 2 rear supports at the rear ski attachments. The turnbuckle between the rear supports keeps the rear skis from sliding out as well as adjusts the distance between the rear skis, and foot pedal brakes on both support pipes stops the snow bike. (For 3-ski snow bike with rear wheel, 2 rear supports swing back and run from rear skis up to the sides of rear wheel and hold up the back of bicycle. The turnbuckle that connects the 2 rear supports keep the rear skis together and adjusts the width between rear skis. The pin connections of the rear supports to the frame permit the up/down motion of rear skis, and can also be adjusted for various snow depth. The 2 support pipes are also bent such that they do not to interfere with bicycle pedaling.)

Our 4^{th} design attaches the 2 support pipes to each side of the bicycle with 2 horizontal pivot bars, such that their ends can freely pivot up/down enabling the bike to lean during turns. The 2 support pipes are pin connected to the ends of the 2 pivot bars that are attached in the center to the bicycle frame by a ½″ bolt. The pivot bars pivot about the connection bolt, moving one end up as the other end moves down. This design allows the rear skis to move up/down as the bike leans during turns. The rear wheel and pedals can also remain attached, so that the 3-ski snow bike can also be used on level surface as well as to go downhill.

The 5^{th} design also uses a horizontal pivot bar to attach the front of support pipes to frame. The midsection of support pipes is connected to sides of frame with 2 swinging rear shock springs, allowing the rear skis to move freely up/down. The foot pedal 9 brakes attached provide stopping power by pushing a bar into snow. (The 2 support pipes can also be bent and installed such that they do not interfere with each other or bicycle pedaling.)

In our 6^{th} design we similarly used a horizontal pivot bar to attach the front of support pipes to frame. The back of snow bike is supported by a bicycle rear spring with a horizontal pivot bar and 2 rear supports attached to support pipes at rear ski attachments. The turnbuckle keeps the rear skis from sliding outwards and provides for distance between rear skis. (For cross country snow bike the rear supports swing back and connect to frame at the rear wheel connection.)

The above designs can also be adapted to work with a complete bicycle (pedals and rear wheel attached), giving us numerous designs for cross country snow bike. Some of these designs are shown in FIG. 9. The connection points are moved up above the bicycle pedals and bending of support pipes is modified such that their motion does not interfere with the pedaling. The foot pedal brakes and rear ski attachments similarly connect to the bottom of support pipes.

These are some of configurations possible using the connection details provided below. Other designs can also be assembled using the details provided. Some of them with 3 points of support are shown in FIG. 1. Additionally the 3-ski designs can be attached to other types of bicycle frames, some also shown in FIG. 1. Even though these designs are not discussed, they also are included as part of invention.

### DESCRIPTION OF DRAWINGS

The basic 3-ski snow bike consists of bicycle frame 3 (with or without rear wheel and pedals), front ski 1 instead of front wheel, and 2 support bars 5 that attach to the sides of the bicycle frame and run down to the 2 rear skis 10. The support bars 5 attach to the bicycle frame 3 such that as one of the rear skis 10 move up the other moves down, enabling the snow bike to lean. A foot pedal brake 9 is attached to each support pipe 5 that digs a bar into snow to slow and stop the snow bike. This invention covers the different ways of how the 2 support pipes 5 can be attached to bicycle frame 3, with the rear wheel and pedals attached for cross country snow biking, or removed for downhill snow biking.

FIG. 1—VARIOUS DESIGNS OF DOWNHILL SNOW BIKES

This drawing shows the various 3-ski snow bike designs (described below) and their adaptation to different style bicycles to make a lightweight downhill racer, or to complete bicycle making it a 3-ski cross country snow bike. A “Mangoose” bicycle frame with rear spring was used because it is easy to remove the entire rear wheel assembly (not needed for downhill snow biking), however our designs are similarly adaptable to different style frames.

FIG. 2—DESIGN 1 (Steering bar and swinging springs connection of support pipes to frame)

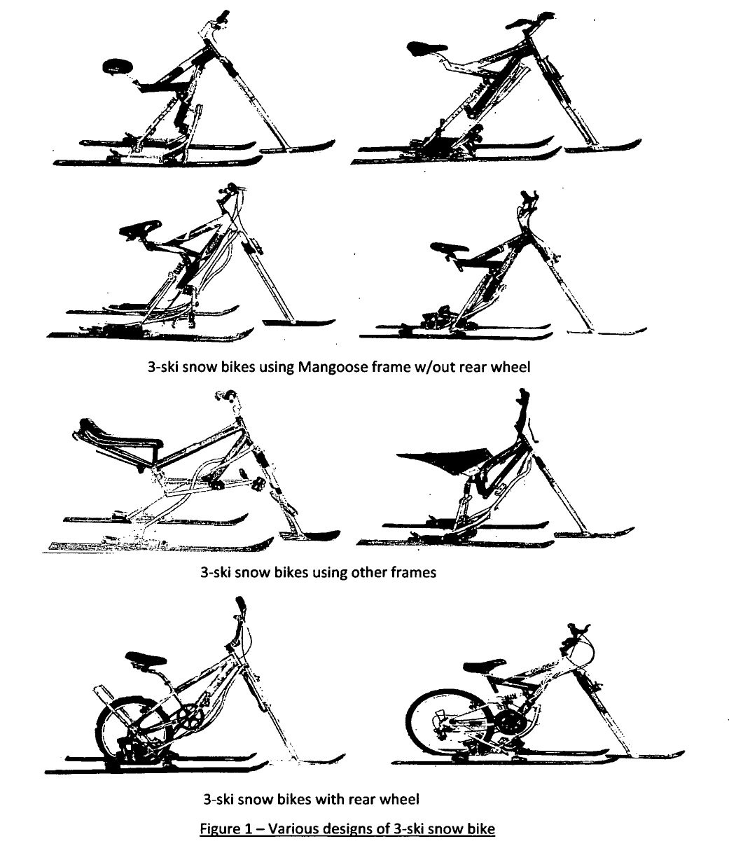

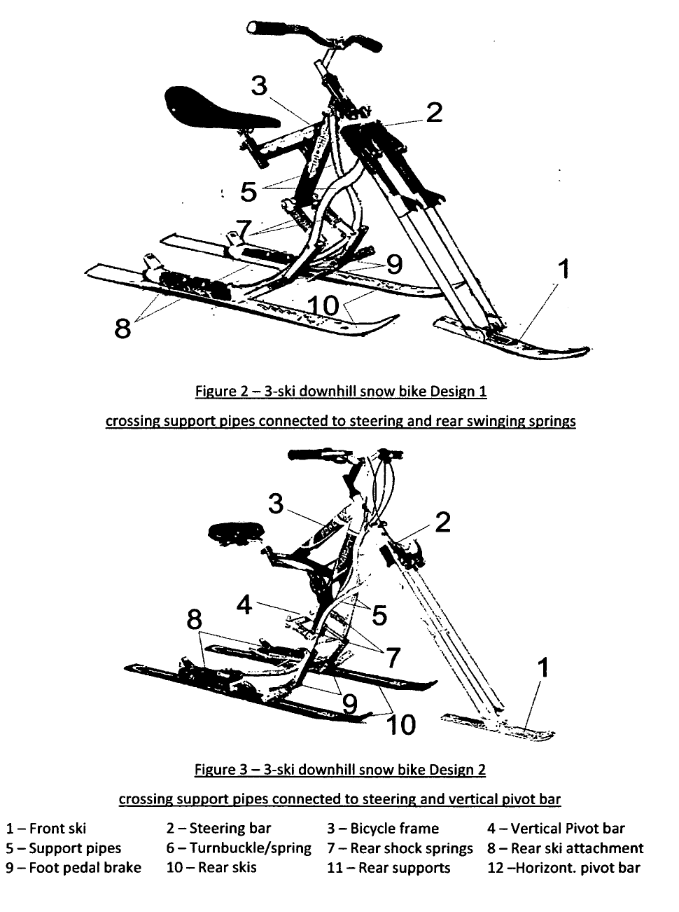

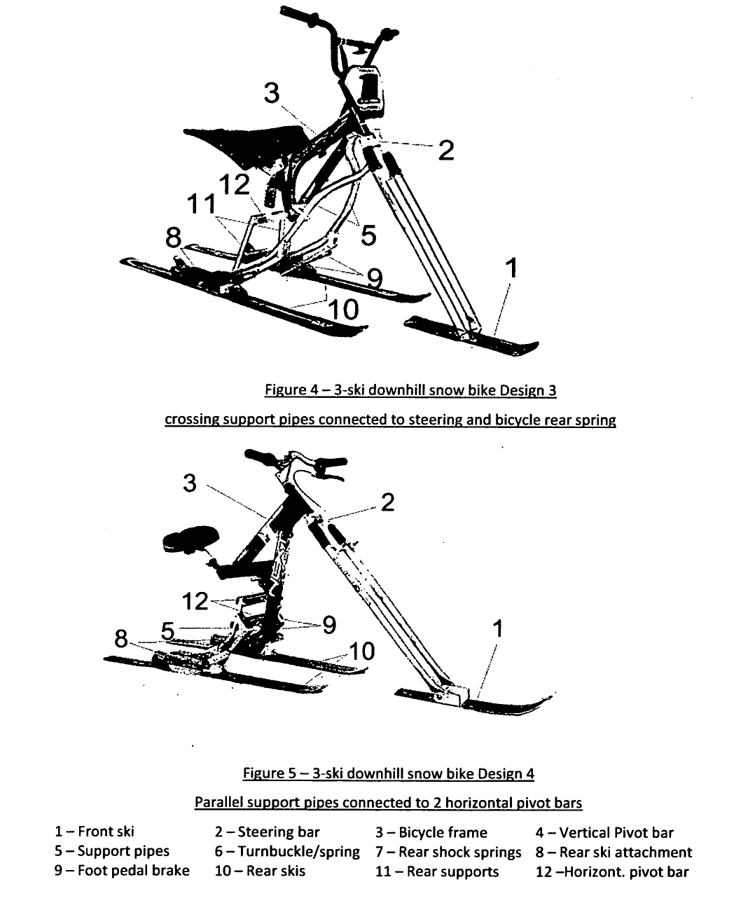

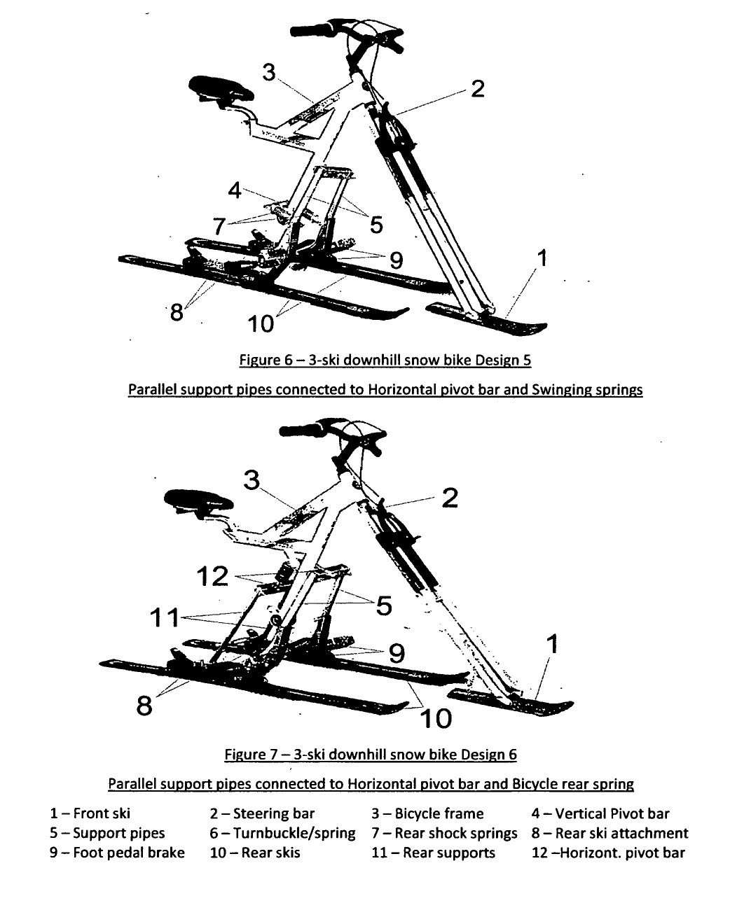

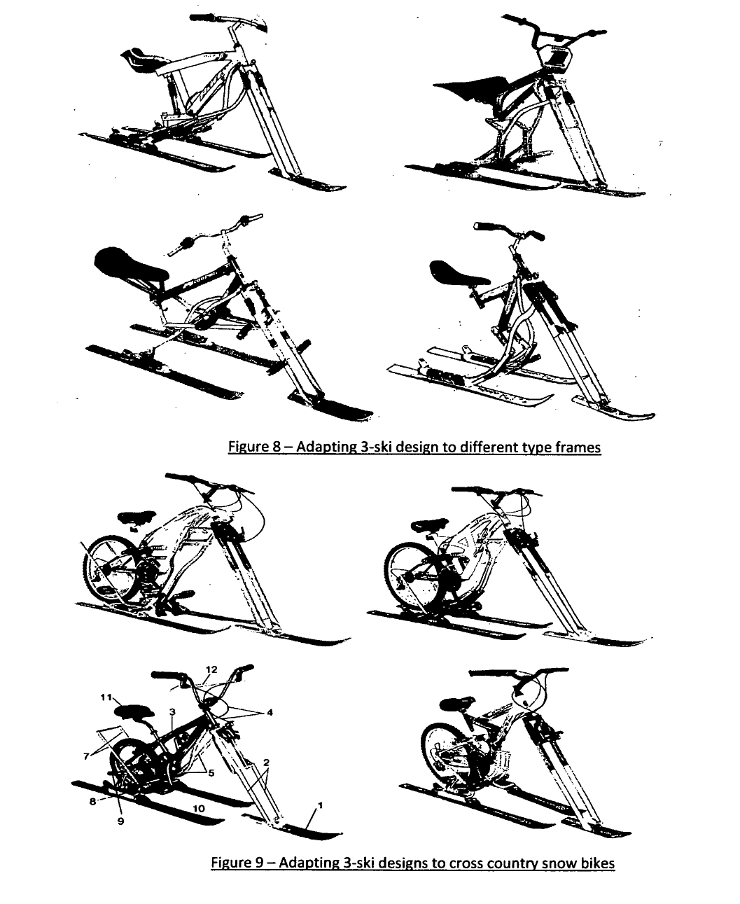

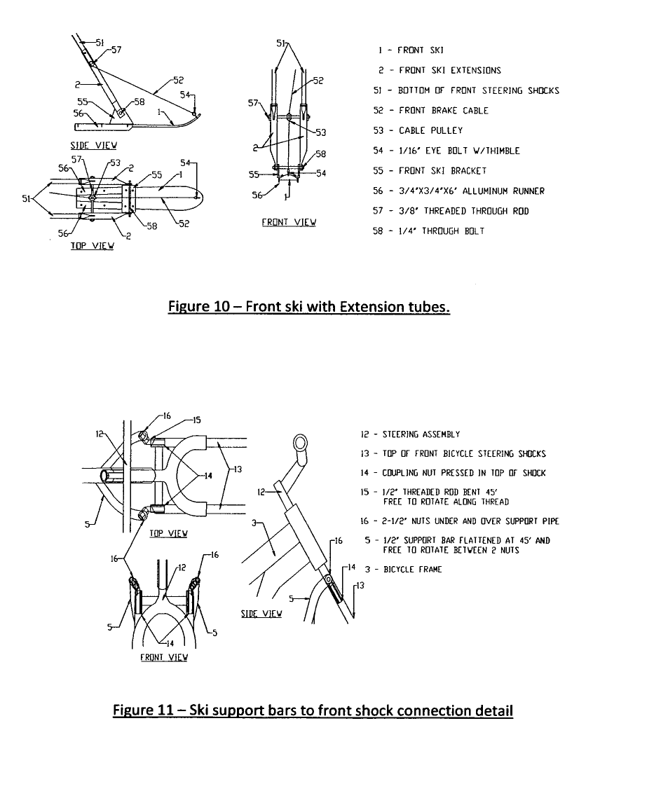

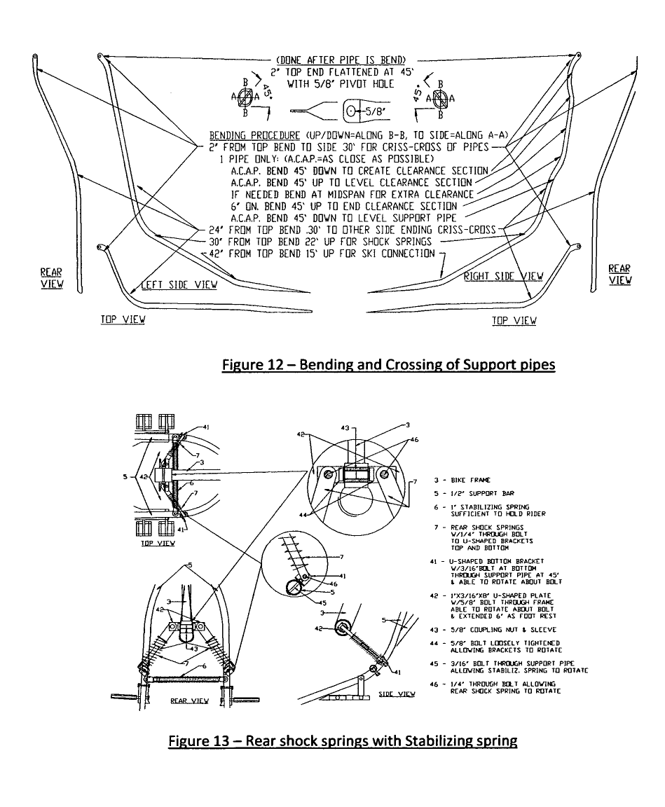

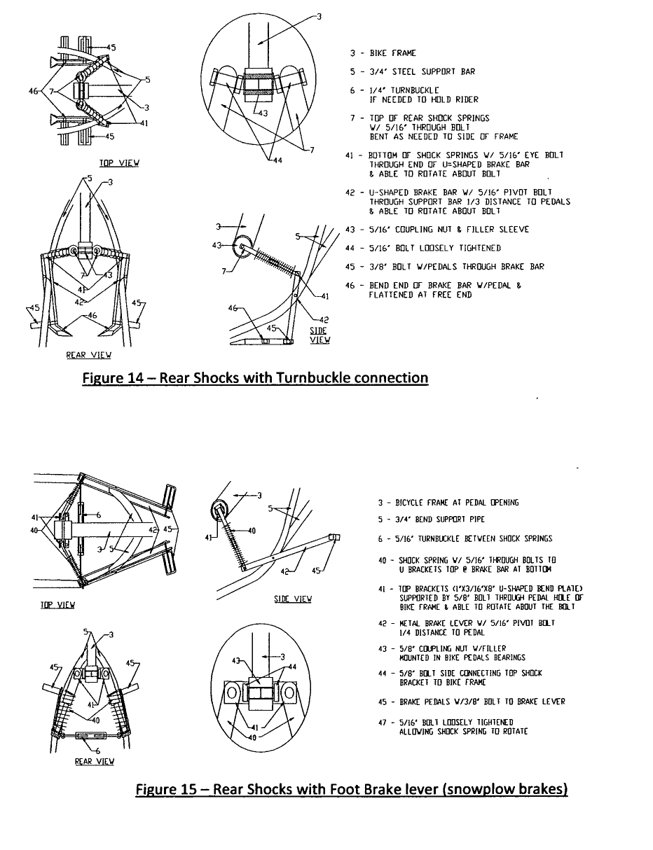

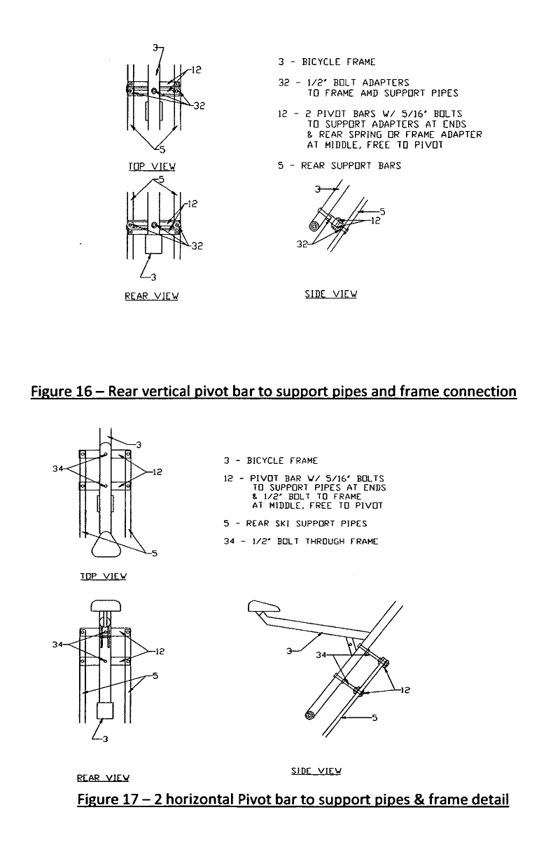

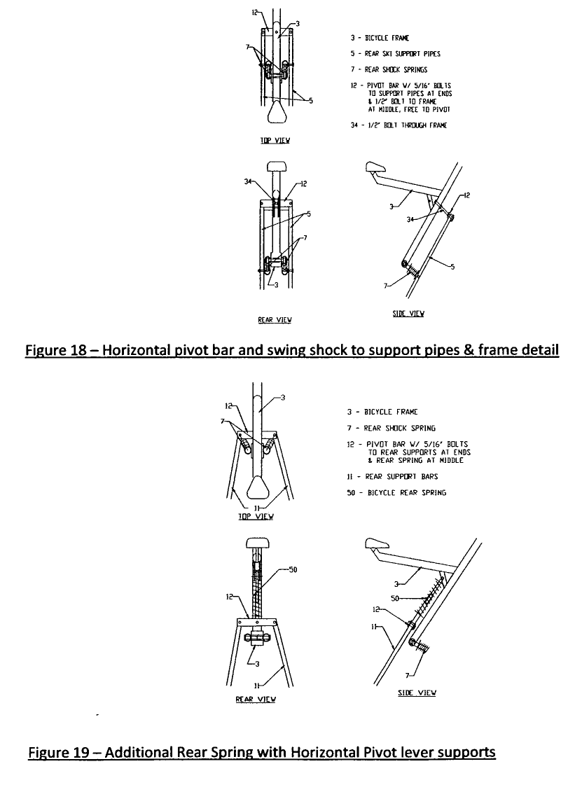

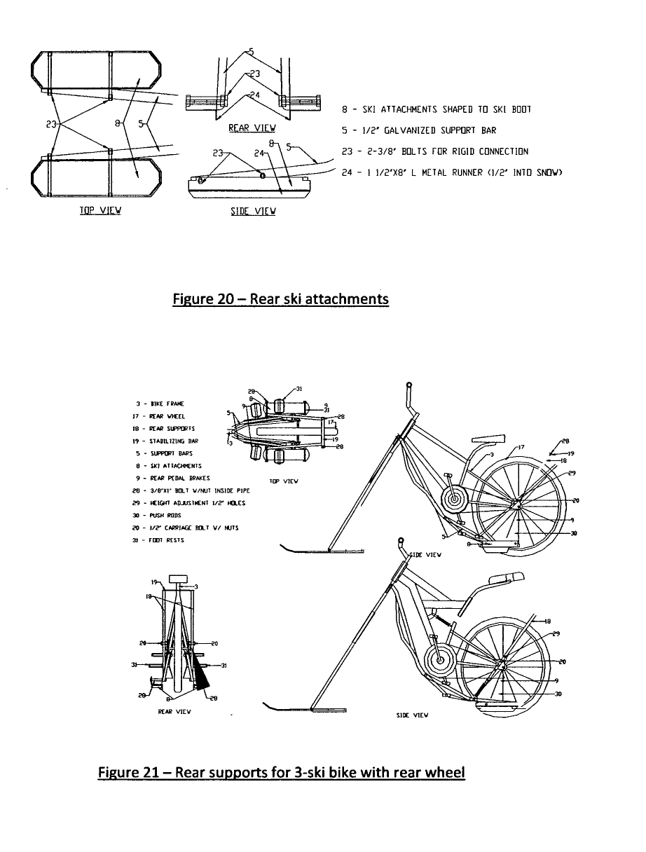

This design connects the front of support pipes 5 to steering, with the rear of frame 3 supported by 2 swinging rear shock springs 7. The 2-¾″ steel support pipes 5 are pin connected to the steering bar 2 and swing springs 7, and run from steering bar to rear skis 10. They are bent to shape described later, and cross each other such that they are able to move up, down and sideways without interfering with each other. This enables the 3-ski snow bike to lean and turn. The 2 rear spring shocks 7 that attach at mid span of the support pipes 5 are pin connected on top to the side of bicycle frame 3 at pedal opening (one on each side of the bicycle frame), and swing such that they allow the up/down motion of rear skis. The bottom of the swinging shock springs 7 are pin connected to the end of a brake bar 9 or to the support pipes 5 directly. Horizontal turnbuckle or stabilizing spring 6 connects the 2 support pipes 5 or foot brake levers 9 to prevent skis from sliding out. And the foot pedal brakes 9 permit the snow bike to slow down and stop.

FIG. 3—DESIGN 2 (Steering bar and vertical pivot bar connection of support pipes to frame)

This 2^{nd} design similarly connects the crossing support pipes 5 to steering bar 2 in front and a vertical pivot bar 12 in the middle. The steering bar 2 connection controls the leaning of the 3-ski snow bike, and the pivot bar 12 provides additional up/down motion of rear skis 10 on steep slopes. Foot pedal brakes 9 are installed on each support pipe 5 that push a bar into snow as brake pedal is pushed down. They work independently and the amount of braking depends on how much the brake bar digs into the snow.

FIG. 4—DESIGN 3 (Steering bar and bicycle spring connection of support pipes to frame)

The 3^{rd} design also connects the crossing support pipes 5 to steering 2 in front and the rear of support pipes 5 attach to the bicycle rear shock by a horizontal pivot bar 12 and 2 rear supports 11 at the rear ski attachments. A second pivot bar 12 is needed for stability at midsection of rear supports 11, that attaches to frame 3 by ½″ bolt and keeps rear skis 10 from sliding out as well as adjusting the distance between them. The pin connections allow the snow bike to lean and the foot pedal brakes 9 are used to slow down and stop the snow bike. (For cross country snow bike the rear supports 11 swing back and attach to sides of the bicycle frame 3 at the rear wheel connection.)

FIG. 5—DESIGN 4 (2 horizontal pivot bars connection of support pipes to frame)

In this 4^{th} design we attached the 2 support pipes 5 to each side of the bicycle 3 with 2 horizontal pivot bars 12, such that they can freely pivot up/down enabling the bike to lean during turns. The support pipes 5 are pin connected to the ends of the 2 pivot bars 12, that are also attached in the center to the bicycle frame 3 with 2-½″ bolts. The pivot bars 12 pivot about the connection bolts, moving one end up as the other end moves down. The attached foot brakes 9 move with support pipes 5 and slow the snow bike as the pedal is pushed down.

FIG. 6—DESIGN 5 (Pivot bar and swinging springs connection of support pipes to frame)

The 5^{th} design uses a pivot bar 12 to attach the front of support pipes 5 to frame 3. The midsection of support pipes 5 is connected to frame 3 with 2 swinging rear shock springs 7, allowing the rear skis 10 to move freely up/down. The 2 support pipes 5 are bent and installed such that they do not interfere with each other or bicycle pedal motion. And the foot pedal 9 brakes attached provide stopping power by pushing a bar into snow.

FIG. 7—DESIGN 6 Pivot bar and bicycle spring connection of support pipes to frame)

In this design we also used a horizontal pivot bar 12 to attach the front of support pipes 5 to frame 3. The back of snow bike is supported by a bicycle rear spring with a horizontal pivot bar 12 and rear support 11 attached to rear ski support pipes 5 at rear ski attachments 8. The second pivot bar 12 along rear supports 11 provides stability and keeps the rear skis 10 from sliding outwards. (For cross country snow bike rear supports 11 swing back and attach to sides of the bicycle frame at the rear wheel connection.)

FIG. 8—ADAPTING THE 3-SKI DESIGNS TO DIFFERENT BICYCLE FRAMES

The downhill 3-ski designs can be similarly adapted to other bicycle frames. Here we provide a few examples using a Moto-bike frame, Compressor bicycle frame, a child's bicycle frame, and a newly build frame. There are a lot more designs possible using the details provided in this invention and are also part of the patent.

FIG. 9—ADAPTING THE 3-SKI DESIGNS TO CROSS COUNTRY SNOW BIKES

The above 3-ski snow bike designs can also be adapted to the bicycles with rear wheel and pedals attached, making the 3-ski snow bike able to move cross-country as well as downhill. The front wheel is similarly replaced with a front ski and attachment of the support pipes is moved up above the pedaling motion. The support pipes are accordingly bend such that they move between the pedals and their motion does not interfere with the pedals or each other's motion. The front brake cable is similarly attached to the front ski and the brake pedals installed below the bicycle pedals. This way a rider can use bicycle pedals with rear wheel to move forward and the attached rear skis to slide on snow. Most of the above designs can be adapted for the cross country 3-ski snow bike. This diagram shows a few adaptations, however other variations of the above designs are possible, and are included as part of this invention.

FIG. 10—FRONT SKI AND 2 EXTENSIONS

The front ski 1 is a 2′ cut ski tip or a kid's ski that is secured to 1″ EMT extension tubes 2 (1 on each side) by a bolt 57 through a bracket 55. The connection is about ½-⅓ distance from the back, perpendicular to the ski, with ski pivoting between the 2 extension tubes. The front ski 1 also has 2-¼″×6″ runners 56 bolted lengthwise under the front ski on each side. These runners keep the front ski 1 from sliding sideway, allowing it to glide straight over the snow.

The extension tubes 2 are 1″ EMT pipe about 18″ long. One end it is connected to the front ski, and the other end is made slightly oval to fit over the bottom section of the front shock 51. This end is rigidly secured to the bottom of front shock 51 such that the shock leg extends straight to the front ski pin connection.

FIG. 11—STEERING BAR & CROSS CONNECTION

The 2 support pipes 5 are held up in the front by top of front steering shocks 13. The pipe is pin connected by ½″ bent bolt 15 through the support pipe, and a ½″ coupling bushing 14 which is pressed into the tube of the front shock. Since the support pipe 5 is able to rotate about the bolt 15, and bolt is able to rotate within the bushing, the circular motion of steering bar is transformed into the forward/up and back/down motion of the support pipes 5 that is needed for turning. By connecting left ski to the right shock, and the right ski to the left shock, the motion of support pipes 5 enables the ski bike to lean in the proper direction, thus utilizing the centripetal force generated by the snow bike. However, the support pipes 5 must bent such that they do not interfere with each other during bike operation. Additionally if the ½″ connection bolt 15 can be bend 45′or 90′, thus providing a second plane of rotation that allows support pipes 5 to move easier up/down.

FIG. 12—CROSS BENDING OF SUPPORT PIPES

The 2 support pipes 5 are ¾″ steel pipes that are attached to steering bar 59 and extend back and down to the 2 skis 10 attached in the back. The 2 bars are bent to shape such that they support the rear of the bicycle frame 3 at about mid section and then extend further back until rear ski connection 8. The ¾″ galvanized pipe is drilled in front with a ½″ hole for steering connection. The other end of the support pipe has a snap in rear ski connection 8 that resembles a standard ski boot for easy attachment to most ski bindings. At midsection the support pipe 5 has a foot brake 9 and back of bicycle frame support connected to it. The rear support is attached such that it allows the forward/back motion of the support bar 5 during steering. The support pipes 5 are bent such that they are able to cross each other and allow the forward/up and back/down motion without interference with each other, and bent again at rear support connection to bring the bicycle seat lower, with support pipes 5 extending back past the seat to rear ski attachments 8.

For ski-bikes with rear wheel, the support bars 5 are similarly connected in the front. The bending and crossing of pipes is modified such that the pipes run under the bike frame and do not interfere with pedal motion of the bicycle. They are pin connected in the back by a bolt to the 2 rear supports 11, which hold up the back of 3-ski bike at the rear wheel.

FIG. 13—REAR SHOCK SPRINGS WITH HAND BRAKES

The 2 rear shock springs 7 hold up the back of the bicycle frame 3. They are rear bicycle springs with a thinner spring and connected on top to the frame by a pivot bar 44 with ½″ bolt in the middle and 2 springs at ends. The bottom of rear spring shocks 7 are connected to support pipes 5 with brackets 41, connected at 45′, allowing the freedom of motion for support pipes 5. The 2 support pipes 5 are also interconnected with a stabilizing spring 6 that restricts the sideway motion of support pipes 5 under the weight of rider. The hand brake cables 47 are attached to rear shock springs 7 and pull the rear skis 10 together and parallel when engaged, or spread out and snowplow when released. Additionally a foot pedal brake 9 is attached to each support pipe 5 that digs a brake bar into snow as rider pushes down on the brake pedal 9.

FIG. 14—REAR SHOCK SPRINGS WITH LEVER FOOT BRAKE 1

The top of the rear spring shocks 7 are directly attached to the sides of the bicycle frame 3 by a ½″ bolt through pedal opening, and the bottom is pin connected to the brake lever at 45′ angle by a 5/16″ eye bolt. The brake lever runs horizontal and made of 2-½×1″×18″ bars bolted together to work as one piece. It goes around the ¾″ support pipe 5 and continues forward to the brake pedal 9 on the other end. The brake lever is pin connected to support pipe 5 by ⅜″ bolt about ¼″ distance from rear spring and able to pivot about the bolt. So as the pedal end of brake bar is pushed down, the rear spring end goes up and under the rider's weight pushes the rear ski out enabling it to snowplow. A turnbuckle 6 that connects the bottoms of shock springs 7 provide additional lateral support. It is pin connected, runs horizontal, and keeps bottom of rear shock springs from sliding out and used to set the distance between rear skis.

FIG. 15—REAR SHOCK SPRINGS WITH LEVER FOOT BRAKE 2

This is another way the foot brake lever 9 is used to force rear skis to snowplow. The top of rear shock springs 7 are directly connected to each side of pedal opening by ½″ bolt into coupling 43 set rigidly inside the opening, allowing the rear shocks to swing but not move sideways. The turnbuckle 6 is used as additional sideway support, and the connection bolt 44 can be bent slightly if greater angle between the rear shock springs 7 is desired. The brake bar 9 is made of 2 bars bolted together to act as one piece and extends down over support pipe 5 to the pedal below. It is pin connected to rear shock springs 7 on top and over the support pipe 5 about ⅓ distance to brake pedal 45 with 5/16 bolts. Another bar with pedal can be attached to the bottom of brake bar, forcing the free end to go into snow as rider pushes on the second pedal. So the rider can snowplow by pushing one pedal, or push a bar into snow with other pedal.

FIG. 16—VERTICAL PIVOT BAR TO FRAME/SPRING AND SUPPORT PIPES CONNECTION

The vertical pivot bar 12 is made from 2 steel plates and 3 coupling adapters, attached to bicycle frame in the middle and support pipes at each end with ½″ through bolts. The steel plates work as one piece and push one end up as the other moved down. The adapters are able to pivot about the connections permitting the support pipes 5 to also move back and forth. This design provides flexibility of rear skis motion while supporting the rider. (Rear shock springs can be used instead of adapters, giving smoother ride.)

FIG. 17—2 HORIZONTAL PIVOT LEVERS TO FRAME AND SUPPORT PIPES CONNECTION

This 2 horizontal pivot bar 12 to frame 3 and support pipes 5 connection also permits the up/down motion of rear skis 10 while transmitting the load of rider to skis. The pivot bar 12 is 2 steel bars attached to frame 3 with ½″ through bolt in the middle and able to rotate about the bolt. The ¾″ support pipes 5 are also pin attached in between the ends of pivot bar 12 by a 5/16″ bolt. This configuration forces one ski to go down as other comes up, allowing the 3-ski snow bike to lean. Since two support points are required for snow bike stability, two such connections are used along the support pipe 5.

FIG. 18—HORIZONTAL PIVOT BAR & SWINGING REAR SPRINGS TO FRAME AND SUPPORT PIPES

This attachment of support pipes 5 to frame 3 is similar to the detail above except for the lower pivot bar 12 is substituted with the swinging rear spring shocks 7 connected to frame through bolt on each side of frame also described before. This configuration allows the desired up/down motion of support pipes 5 and rear skis 10 while supporting the load.

FIG. 19—BICYCLE REAR SPRING WITH PIVOR BAR SUPPORT

The rear bicycle spring 40 is also used to provide support of the rider. The spring remains connecter to frame as before. To the bottom of the spring, pivot bar 12 is attached in the middle by 5/16″ bolt such that it can pivot. It is 2 steel plates on each side of rear spring and supports connected together with 5/16″ through bolt. The rear support pipes 5 pin connected at each end, and transfers the load of rider directly to rear skis. A turnbuckle between rear supports keeps rear skis from sliding apart and adjusts width between skis.

FIG. 20—REAR SKI ATTACHMENTS

The rear ski attachments 8 are shaped same as the bottom of ski boot, and allow easy snap in of most downhill skis 10 on the market, permitting the rider to choose the ski length and type desired. They are secured to the bottom end of the support pipe 5 with 2 bolts such that it moves together with the support pipe as 1 piece, forcing the rear ski to ride on its edge during turns. The rear ski attachments 8 also have a ½×8″ runners 24 on the inside bottom to stabilize the forward motion of the ski-bike, and the top of the attachment is covered with a rough surface so the rider can stand on the attachments 8.

FIG. 21—REAR SUPPORTS FOR 3-SKI BIKE WITH REAR WHEEL

Because of the rear wheel 17, the back of the 3-ski bike is now supported by 2 solid rear supports 18 that run from the rear skis attachments 9 upward to the rear of the bike where the rear wheel 17 connects. They are ½″ galvanized pipes that connect to support pipes on the bottom and extend past the top of rear wheel 17, with series of ½″ holes drilled at midsection for adjustable connection to bicycle frame 3. The support pipes 5 and rear supports 18 are also pin connected allowing rear supports to swing. Bicycle frame 3 connects to rear supports 18 with ½×2″ bolt 21, through one of height adjustment holes at midsection. A turnbuckle 19 on top holds the 2 rear supports 18 from sliding out sideways, and controls the distance between skis.

### PRIOR APPLICATIONS

| | | | |
|---|---|---|---|
| U.S. Pat. No. 7,896,362 | B1 | Mar. 1, 2011 | Seatchard |
| US 2010/0264612 | A1 | Oct. 21, 2010 | Paganoni at al |
| US 2010/0109267 | A1 | May 6, 2010 | Leycraft |
| US 2010/0109310 | A1 | May 6, 2010 | Gulbranson |
| US 2009/0230641 | A1 | Sep. 17, 2009 | Eugenio |
| U.S. Pat. No. 7,540,506 | B2 | Jun. 2, 2009 | Cheney at al |
| US 2008/0258414 | A1 | Oct. 23, 2008 | Ferron |
| US 2008/0029324 | A1 | Feb. 7, 2008 | Plankenhorn |
| U.S. Pat. No. 7,232,133 | B2 | Jun. 19, 2007 | Stevens |
| US 2006/0197294 | A1 | Sep. 7, 2006 | Yau |
| US 2006/0151965 | A1 | Jul. 13, 2006 | Calitz |
| U.S. Pat. No. 6,994,359 | B1 | Feb. 7, 2006 | Silver |
| US 2004/0238251 | A1 | Dec. 2, 2004 | Oron at al |
| U.S. Pat. No. 6,736,414 | B2 | Mar. 18, 2004 | Farrally-Plourde |
| US 2003/0222419 | A1 | Dec. 4, 2003 | Geary |
| U.S. Pat. No. 6,626,441 | B2 | Sep. 30, 2003 | Hanson |
| US 2004/0155416 | A1 | Aug. 12, 2004 | Liu at at |
| US 2003/0122330 | A1 | Jul. 3, 2003 | Nelson |
| U.S. Pat. No. 6,554,294 | B2 | Apr. 29, 2003 | Laudon |
| US 2003/0038434 | A1 | Feb. 27, 2003 | Farrally-Plourde |
| U.S. Pat. No. 6,511,079 | B1 | Jan. 28, 2003 | Charles |
| U.S. Pat. No. 6,575,479 | B2 | Jun. 10, 2003 | Combs |
| U.S. Pat. No. 6,416,062 | B1 | Oct. 9, 2002 | Seatchard |
| U.S. Pat. No. 6,431,301 | B1 | Aug. 13, 2002 | Forbes |
| U.S. Pat. No. 6,241,265 | B1 | Jun. 5, 2001 | Koval at at |
| U.S. Pat. No. 6,279,923 | B1 | Sep. 28, 2001 | Cardillo at at |
| U.S. Pat. No. 6,112,840 | | Sep. 5, 2000 | Forbes |
| U.S. Pat. No. 6,164,670 | | Dec. 26, 2000 | Abarca |
| U.S. Pat. No. 5,738,361 | | Apr. 14, 1998 | Landucci |

The unity of this invention is different ways 3 skis (1 in front and 2 in the back) can be attached to a bicycle frame. All designs have a front ski that steers the snow bike, and 2 rear ski support pipes attached to the sides of bicycle frame that support the back of the frame and rider. The support pipes requires minimum of two connection points for stability and are able to move up/down to enable the 3-ski snow bike to lean. The claims below provide different variations on how the 2 rear ski support pipes can be connected to bicycle frame. Claims 2-4 attach the top of rear ski support pipes to the steering bar, and use 2 swinging spring shocks (claim 2), vertical pivot bar at midsection (claim 3), or vertical pivot bar at rear spring (claim 4) to support the rear of frame and rider. Claim 5-7 pin connect the top of rear ski support pipes by horizontal pivot bar, and at mid span support frame and rider by another horizontal pivot bar (claim 5), 2 swinging spring shocks (claim 6), or vertical pivot bar at rear spring (claim 7). Additionally, all above variations of connecting 2 rear ski can be used on bicycles with rear wheel and pedals attached (claim 9), or with other types of frames (claim 8).

1. The 3-ski snow bike consists of
Bicycle frame without rear wheel and pedals;
Front ski with extensions attached to bottom of steering bar front shocks;
2 rear ski support pipes with ski attachments;
that are secured to the sides of said frame by various connection details provided (horizontal pivot bar or steering bar on top; horizontal pivot bar, vertical pivot bar or 2 swing springs at midsection; or vertical pivot bar at rear spring at bottom);
and a foot brake that is attached to each support pipe.

2. The 1^{st} version of 3 ski snow bike of claim 1 cross attaches the top of rear ski support pipes to the steering bar, and the midsection to the sides of the bicycle frame with 2 swinging spring shocks.

3. The 2^{nd} design of claim 1 3-ski snow bike also cross attaches the top of rear ski support pipes to the steering bar. However the midsection is now connected to the ends of vertical pivot bar, with bicycle frame connected in the middle. The vertical pivot bar gives this design greater flexibility on steep slopes.

4. In the 3^{rd} design of claim 1 3-ski snow bike the 2 rear ski support pipes are cross connected on top, and on the bottom with 2 rear supports that pin attach to the ends of vertical pivot bar, with the bicycle rear string in the middle. This design can be attached to a bicycle without drilling through the frame.

5. The 4^{th} design of claim 1 3-ski snow bike, the top of rear ski support pipes are pin connected with a horizontal pivot bar at ends and bicycle frame in the middle. The mid section is connected to frame by another horizontal pivot bar. This permits the rear skis to freely move up/down.

6. The 5^{th} version of claim 1 3-ski snow bike, the top of rear ski support pipes are also pin connected to a horizontal pivot bar. And the midsection supports the bike frame by 2 swinging spring shock. The horizontal pivot bar permits free up/down motion of rear skis, and the spring shocks a smoother ride.

7. The 6^{th} version of claim 1 snow bike also pin attaches the top of rear ski support pipes with a horizontal pivot bar to frame. However the back of frame is supported by 2 rear supports that pin connect on top to the ends of vertical pivot bar with bicycle rear spring in middle.

8. The 6 versions of claim 1 snow bike can also be adapted to different types of bicycle frame. Some of these designs are shown in FIG. 8.

9. Also the 6 versions of claim 1 snow bike can be adapted to a bicycle with the rear wheel and pedals attached. Some of these designs are show in FIG. 9.

10. FIGS. 10-21 show the various construction drawings of front ski, different rear ski support pipes connections and brakes designs, and ski attachments details
Fallowing claims are intended to cover all of the generic and specific features of invention described, and are included as part of this invention.
ALTERNATIVE EMBODIMENTS
Other 3-ski snow bike designs are possible using the construction details provided. Also the connection locations can be moved, with support pipes bent accordingly. Different frames can be designed, not just ready-made bicycle frames. Hand cable brake system can also be added to the above designs. And seat can be modified, even to carry 2 persons.
In addition the material in fabricating the 3-ski bike can be varied to other types of metal like aluminum, stainless steel, and others. Square, round or rectangular tubing can also be used instead of galvanized pipe utilized in our design. Furthermore size and shape of ski bike can be changed to accommodate different sizes and abilities of riders.
